(19) United States
(12) Patent Application Publication
(10) Pub. No.: US 2025/0045710 A1
(43) Pub. Date: Feb. 6, 2025

(54) GARBAGE COLLECTION SYSTEM AND TRAINED MODEL

(71) Applicant: NTT DOCOMO, INC., Tokyo (JP)

(72) Inventors: Hiromasa KITAI, Chiyoda-ku (JP); Hiroto AKATSUKA, Chiyoda-ku (JP); Masayuki TERADA, Chiyoda-ku (JP); Motoko SUZUKI, Chiyoda-ku (JP); Takako KOMINATO, Chiyoda-ku (JP)

(73) Assignee: NTT DOCOMO, INC., Tokyo (JP)

(21) Appl. No.: 18/691,195

(22) PCT Filed: Jul. 20, 2022
(86) PCT No.: PCT/JP2022/028209

§ 371 Date: Mar. 12, 2024

(30) Foreign Application Priority Data
Sep. 28, 2021 (JP) 2021-157923

(51) Int. Cl. G06Q 10/30

(52) U.S. Cl. CPC G06Q 10/30

(57) ABSTRACT

A garbage collection system (1) includes: a data acquisition unit (11) that acquires population change data for each district divided in advance and garbage amount record data for each district and each garbage type; and a garbage amount prediction unit (12) that predicts the amount of garbage in each district for each garbage type based on the population change data for each district and the garbage amount record data for each district and each garbage type that have been acquired by the data acquisition unit (11).

### TECHNICAL FIELD

The present disclosure relates to a garbage collection system having a function of predicting the amount of garbage in each district divided in advance and a trained model used in the garbage collection system. In addition, the garbage collection system can also have a function of optimizing the garbage collection route according to the predicted amount of garbage value in each district.

### BACKGROUND ART

Conventionally, there has been a problem of more efficiently collecting garbage generated in daily life. In addition, due to the rapid increase in the number of people working from home due to the spread of the new coronavirus in recent years, the amount of garbage generated from households is increasing. For this reason, techniques for efficiently collecting the increasing amount of garbage have been proposed (see Patent Literature 1 below).

### CITATION LIST

### Patent Literature

Patent Literature 1: Japanese Unexamined Patent Publication No. 2020-004076

### SUMMARY OF INVENTION

### Technical Problem

However, Patent Literature 1 does not describe a technique from the perspective of accurately predicting the amount of garbage in each district to be collected for each garbage type, which is a prerequisite for efficiently collecting garbage. Accordingly, there is a long-awaited technique for accurately predicting the amount of garbage in each district to be collected for each garbage type.

The present disclosure has been made to solve the above problem, and it is an object of the present disclosure to accurately predict the amount of garbage in each district to be collected for each garbage type.

### Solution to Problem

There is a technique for acquiring population change data indicating a population change in each district divided in advance by using the mechanism of a wireless network used by the user's mobile terminal. Therefore, by using the population change data, the applicant has invented the following technique for accurately predicting the amount of garbage in each district for each garbage type based on the knowledge that the amount of garbage discharged (that is, the amount of garbage to be collected (hereinafter, referred to as “the amount of garbage”)) fluctuates with a population change.

A garbage collection system according to the present disclosure includes: a data acquisition unit that acquires population change data for each of districts divided in advance and garbage amount record data for each of the districts and each of garbage types; and a garbage amount prediction unit that predicts an amount of garbage in each of the districts for each of the garbage types based on the population change data for each of the districts and the garbage amount record data for each of the districts and each of the garbage types that have been acquired by the data acquisition unit.

In the garbage collection system described above, the data acquisition unit acquires population change data for each district and garbage amount record data for each district and each garbage type, and the garbage amount prediction unit predicts the amount of garbage in each district for each garbage type based on the acquired population change data for each district and the acquired garbage amount record data for each district and each garbage type. As an example of “garbage amount prediction” herein, a garbage amount prediction model for predicting the amount of garbage for each district may be generated for each garbage type by machine learning, and the amount of garbage for each district may be predicted for each garbage type by using the generated garbage amount prediction model. As described above, it is possible to accurately predict the “amount of garbage for each district”, which fluctuates according to the population change indicated by the population change data, for each garbage type.

### Advantageous Effects of Invention

According to the present disclosure, it is possible to accurately predict the amount of garbage in each district to be collected for each garbage type.

### BRIEF DESCRIPTION OF DRAWINGS

FIG. 1 is a functional block diagram of a garbage collection system.

FIG. 2 is a flowchart showing processing performed in the garbage collection system.

FIG. 3(a) is a diagram for explaining the generation of a garbage amount prediction model by machine learning, and FIG. 3(b) is a diagram for explaining garbage amount prediction using the garbage amount prediction model.

FIG. 4 is a diagram for explaining garbage collection route determination processing.

FIG. 5 is a diagram showing an example of determining a garbage collection route by optimizing both the total travel distance and the total number of vehicles.

FIG. 6 is a diagram showing an example of determining a garbage collection route by optimizing only the total number of vehicles.

FIG. 7 is a diagram showing an example of determining a garbage collection route in which none of the total travel distance and the total number of vehicles are optimized.

FIG. 8 is a functional block diagram of a garbage collection system in a first modification example.

FIG. 9(a) is a diagram for explaining the generation of a garbage collection route determination model by machine learning, and FIG. 9(b) is a diagram for explaining garbage collection route determination using the garbage collection route determination model.

FIG. 10 is a flowchart showing garbage collection route determination processing in the first modification example.

FIG. 11 is a functional block diagram of a garbage collection system in a second modification example.

FIG. 12 is a diagram showing an example of the hardware configuration of each device included in the garbage collection system.

### DESCRIPTION OF EMBODIMENTS

Embodiments of a garbage collection system according to the present disclosure will be described with reference to the accompanying diagrams.

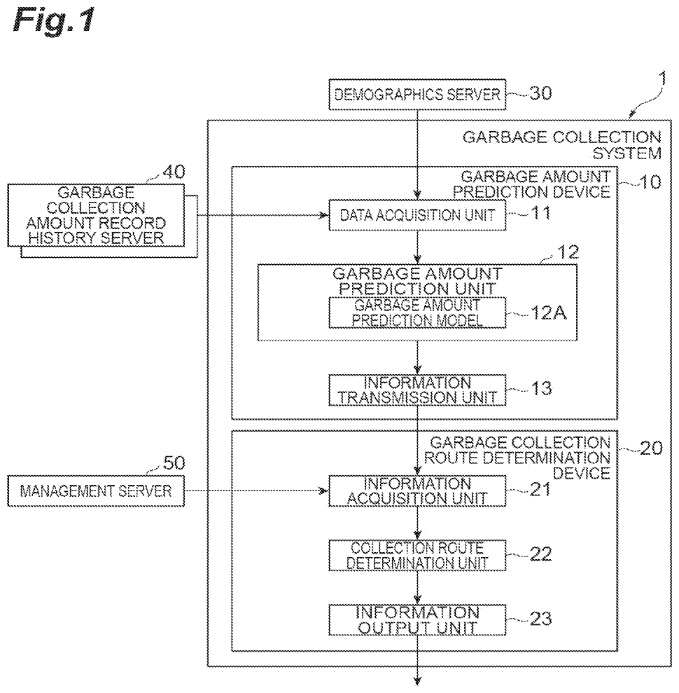

As shown in FIG. 1, a garbage collection system 1 includes a garbage amount prediction device 10 that predicts the amount of garbage and a garbage collection route determination device 20 that determines a garbage collection route. In addition, as peripheral devices of the garbage collection system 1, there are a demographic statistics server 30, a garbage collection amount record history server 40, and a management server 50. The demographic statistics server 30 is a server that acquires and provides population change data indicating a population change in each district divided in advance by using the structure of a wireless network used by the user's mobile terminal. In addition, the present embodiment will be described by using an example in which a district (hereinafter referred to as a “mesh”) divided in advance in a mesh shape along boundary lines along the north, south, east, and west directions is used as a district divided in advance. However, it is not essential to use a mesh, and other divided districts such as cho-chome (Japanese name of unit of district) in administrative divisions may be used. The garbage collection amount record history server 40 is a server that acquires and provides garbage amount record data for each mesh and each garbage type, and is provided for each mesh, for example. The management server 50 is a server that manages and provides various kinds of management information (for example, location information regarding the departure points and destinations of garbage trucks and garbage collection locations for each mesh, information on the collectable amount (hereinafter, also referred to as “capacity”) of each garbage truck, and information on the number of personnel and vehicles that can be dispatched).

In the garbage collection system 1, the garbage amount prediction device 10 includes a data acquisition unit 11, a garbage amount prediction unit 12, and an information transmission unit 13, and the garbage collection route determination device 20 includes an information acquisition unit 21, a collection route determination unit 22, and an information output unit 23. Hereinafter, the function of each unit will be described.

The data acquisition unit 11 is a functional unit that acquires population change data for each mesh divided in advance from the demographic statistics server 30 and acquires garbage amount record data for each mesh and each garbage type from the garbage collection amount record history server 40. In addition, the “garbage type” refers to the type of garbage such as combustible garbage, incombustible garbage, recyclable garbage, and bulky garbage.

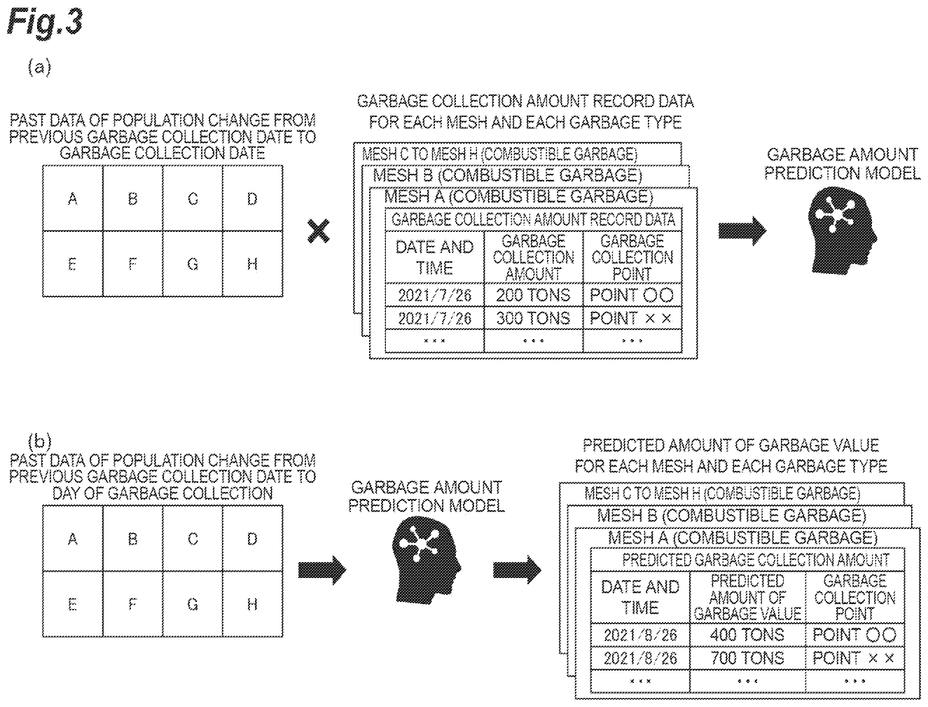

The garbage amount prediction unit 12 is a functional unit that predicts the amount of garbage in each mesh for each garbage type based on the population change data for each mesh and the garbage amount record data for each mesh and each garbage type that are acquired by the data acquisition unit 11. Details of the prediction processing of the garbage amount prediction unit 12 will be described later with reference to FIG. 3.

The information transmission unit 13 is a functional unit that transmits to the garbage collection route determination device 20 the information on the predicted amount of garbage value for each mesh and each garbage type obtained by the prediction processing of the garbage amount prediction unit 12.

The information acquisition unit 21 is a functional unit that acquires various kinds of information necessary for determining the garbage collection route. For example, the information acquisition unit 21 acquires information on the predicted amount of garbage value for each mesh and each garbage type from the information transmission unit 13, acquires from the management server 50 location information regarding the departure points and destinations of garbage trucks used for garbage collection and garbage collection locations for each mesh, information on the collectable amount (capacity) of each garbage truck, and information on the number of personnel and vehicles that can be dispatched, and acquires, from the garbage collection amount record history server 40, information on pre-requested rules for determining the number of required personnel according to the amount of garbage to be collected. In addition, the above-described information on rules does not need to be acquired every time, and may be acquired each time there is a revision.

The collection route determination unit 22 is a functional unit that determines, for each garbage type, a garbage collection route for each garbage truck and the assignment of personnel to each garbage truck. For the garbage collection route determination processing of the collection route determination unit 22, there are (a) a method of determining the garbage collection route for each garbage truck by solving an optimization problem to minimize an evaluation function whose output values are the total travel distance of garbage trucks and the total number of garbage trucks and (b) a method of generating a garbage collection route determination model for determining the garbage collection route for each garbage truck by machine learning and determining the garbage collection route for each garbage truck by using the garbage collection route determination model. In addition, the “total number” of garbage trucks means the number of garbage trucks obtained by counting “the total number as 1 vehicle” until one garbage truck reaches its destination (garbage disposal site) and counting “the total number as 2 vehicles” in a case where the one garbage truck moves again from the destination (garbage disposal site) to the garbage collection site to collect garbage and reaches the destination (garbage disposal site) again.

In the present embodiment, the method (a) above will be described, but the method (b) above will be described later in a first modification example. In addition, the collection route determination unit 22 further determines the assignment of personnel to each garbage truck for each garbage type based on the garbage collection amount for each garbage truck determined according to the determined garbage collection route and pre-requested rules for determining the number of required personnel according to the amount of garbage to be collected.

The information output unit 23 is a functional unit that outputs information on the garbage collection route for each garbage truck and the assignment of personnel to each garbage truck determined by the collection route determination unit 22. “Output” herein can take various forms, such as display on a display, audio output from a speaker, printing by a printer, and data output to an external device.

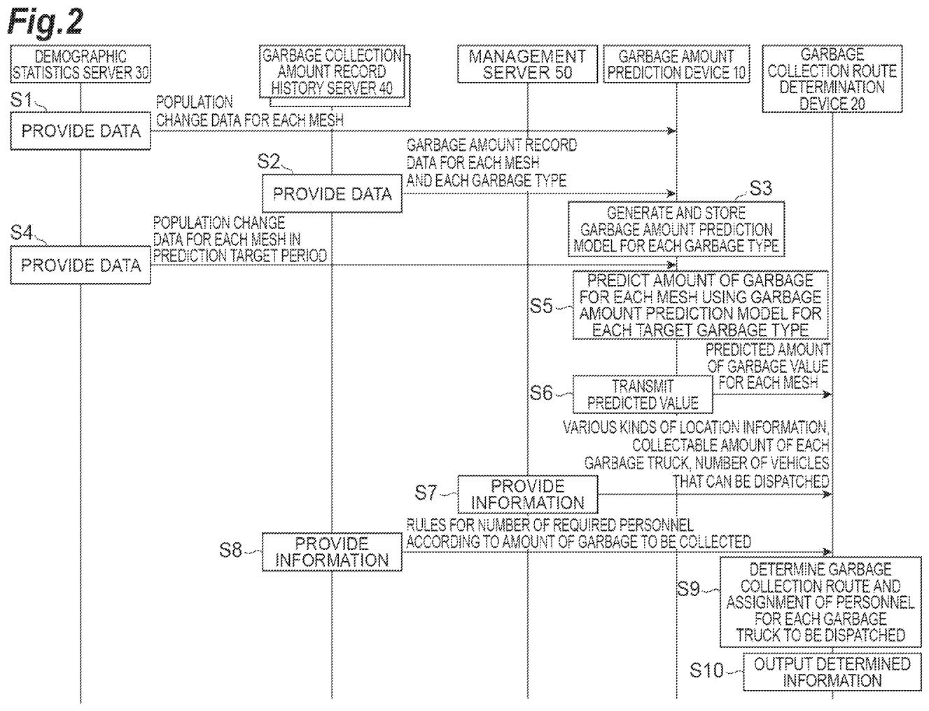

Next, processing performed in the garbage collection system 1 will be described with reference to the flowchart of FIG. 2. The execution timing of this processing is any execution timing, and it is possible to adopt various patterns, such as a timing scheduled in advance and a timing at which the operator of the garbage amount prediction device 10 inputs a start command.

First, the demographic statistics server 30 provides population change data for each mesh to the garbage amount prediction device 10 (step S1), and the data acquisition unit 11 of the garbage amount prediction device 10 acquires the provided data. In addition, the garbage collection amount record history server 40 provides garbage amount record data for each mesh and each garbage type to the garbage amount prediction device 10 (step S2), and the data acquisition unit 11 of the garbage amount prediction device 10 acquires the provided data.

Then, the garbage amount prediction unit 12 generates and stores a garbage amount prediction model 12A for each garbage type as follows (step S3). For example, as shown in FIG. 3(a), the garbage amount prediction unit 12 generates the garbage amount prediction model 12A, which predicts the amount of garbage in each mesh, for each garbage type by performing machine learning for each garbage type by using population change data for each mesh in a past predetermined period (for example, from the previous garbage collection date to the current garbage collection date) as an explanatory variable and garbage amount record data for each mesh and each garbage type in the above predetermined period as an objective variable.

Generally, since the garbage collection timing (day of the week) differs depending on the garbage type, processes from step S4 in FIG. 2 are executed at different timings depending on the garbage type. Although an example in which combustible garbage is targeted as the garbage type will be described hereinafter, the same processing can also be applied to garbage types other than the combustible garbage.

When the garbage collection date for the target garbage type (here, for example, combustible garbage) comes and it is the timing to predict the amount of garbage for the target garbage type, the demographic statistics server 30 provides the garbage amount prediction device 10 with population change data for each mesh in a prediction target period (for example, from the previous garbage collection date to the current garbage collection date) (step S4). The data acquisition unit 11 of the garbage amount prediction device 10 acquires the provided population change data for each mesh. The garbage amount prediction unit 12 predicts the amount of garbage for each mesh related to the target garbage type (combustible garbage) by inputting the population change data for each mesh in the prediction target period to the garbage amount prediction model 12A for the target garbage type (combustible garbage) as shown in FIG. 3(b). The information on the predicted amount of garbage value for each mesh and each target garbage type obtained by this prediction is transmitted from the garbage amount prediction unit 12 to the information transmission unit 13, and the information transmission unit 13 transmits the information on the predicted amount of garbage value for each mesh and each target garbage type to the garbage collection route determination device 20 (step S6). Similarly, the management server 50 transmits to the garbage collection route determination device 20 location information regarding the departure points and destinations of garbage trucks used for garbage collection and garbage collection locations for each mesh, information on the collectable amount (capacity) of each garbage truck, and information on the number of personnel and vehicles that can be dispatched (step S7). The garbage collection amount record history server 40 transmits to the garbage collection route determination device 20 information on rules regarding the number of required personnel according to the amount of garbage to be collected (step S8). In addition, step S8 does not need to be executed every time, and may be executed each time the above rules are revised.

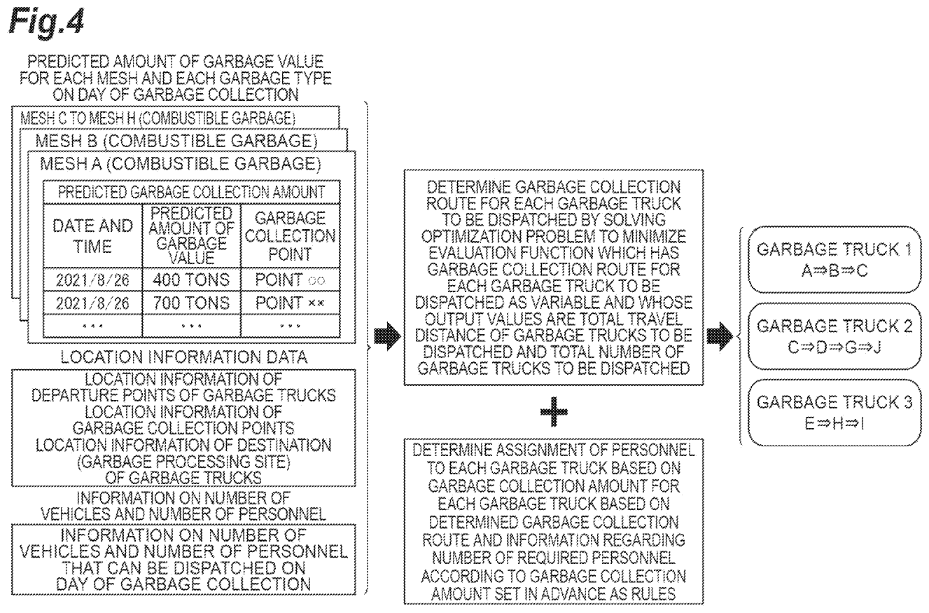

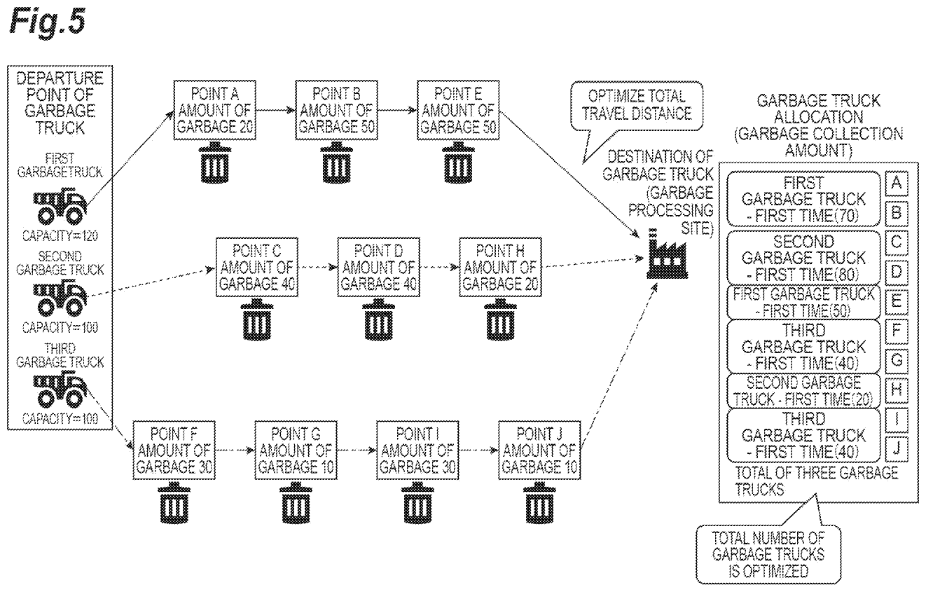

The information acquisition unit 21 of the garbage collection route determination device 20 acquires the various kinds of information described above and transmits the acquired various kinds of information to the collection route determination unit 22, and the collection route determination unit 22 determines a garbage collection route for each garbage truck and the assignment of personnel to each garbage truck for the target garbage type (combustible garbage) as follows (step S9). For example, the collection route determination unit 22 determines a garbage collection route for each garbage truck to be dispatched by solving an optimization problem to minimize an evaluation function, which has the garbage collection route for each garbage truck to be dispatched as a variable and of which output values are the total travel distance of garbage trucks to be dispatched and the total number of garbage trucks to be dispatched, from the predicted amount of garbage value for each mesh and each garbage type (here, combustible garbage) on the day of garbage collection, the location information of the departure point of the garbage truck, the location information of the garbage collection point, the location information of the destination (garbage processing site) of the garbage truck, and the information on the number of garbage trucks and personnel who can be dispatched on the day of garbage collection that are shown on the left side of FIG. 4. In addition, the collection route determination unit 22 determines the assignment of personnel to each garbage truck within a range having the number of personnel who can be dispatched as its upper limit, based on the garbage collection amount for each garbage truck based on the determined garbage collection route and the rule information regarding the number of required personnel according to the garbage collection amount. Then, the information on the determined garbage collection route and personnel assignment for each garbage truck is transmitted from the collection route determination unit 22 to the information output unit 23, and the information output unit 23 outputs the information on the garbage collection route and personnel assignment for each garbage truck (step S10). For example, the information on the garbage collection route and personnel assignment for each garbage truck is output for display on an operator terminal (not shown) of the garbage collection route determination device 20, so that the operator can recognize the garbage collection route and personnel assignment for each garbage truck that are optimized as illustrated in FIG. 5. As a result, It is possible to realize garbage collection management with optimal personnel assignment and optimal garbage collection routes.

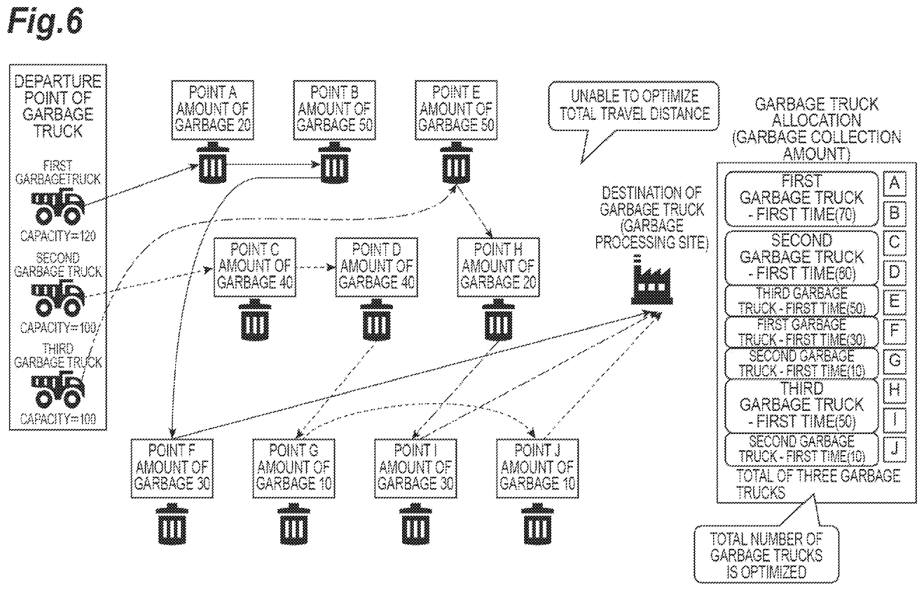

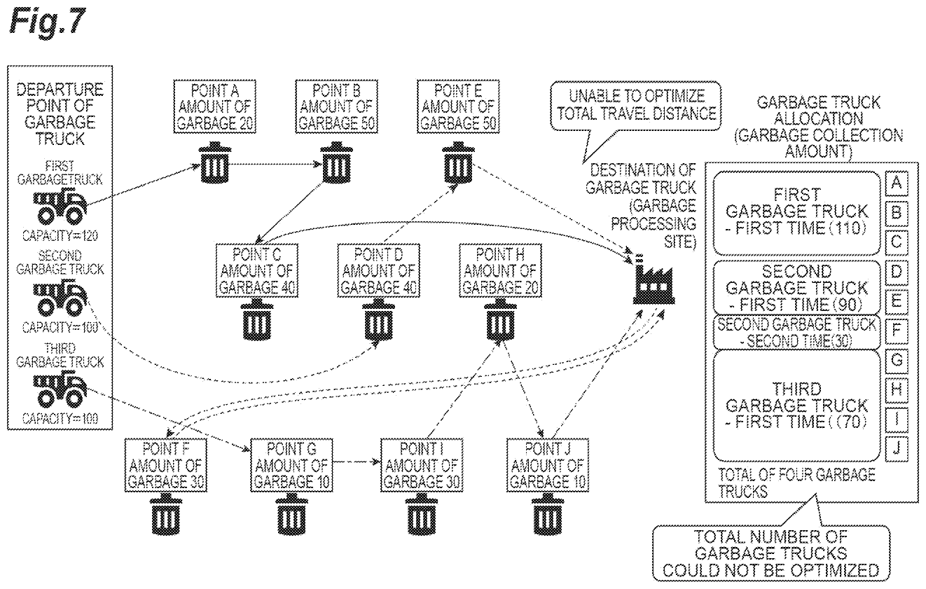

Here, examples of determining the garbage collection route will be outlined with reference to FIGS. 5 to 7. The collection route determination unit 22 determines a garbage collection route that minimizes the total travel distance of garbage trucks and the total number of garbage trucks. In the example of determining the garbage collection route shown in FIG. 5, a garbage collection route is adopted that is optimized so that each garbage truck collects garbage within the range of the collectable amount (capacity) and both the total travel distance of garbage trucks and the total number of garbage trucks are minimized. On the other hand, in the example of determining the garbage collection route shown in FIG. 6, a garbage collection route is adopted that is optimized so that the total number of garbage trucks is “3”, which is the same as in FIG. 5, but is not optimized in terms of the total travel distance because the total travel distance increases. In addition, in the example of determining the garbage collection route shown in FIG. 7, a garbage collection route is adopted that is not optimized because the second garbage truck reaches its destination (garbage disposal site) twice and accordingly the total number of garbage trucks “4”, which is larger than in FIGS. 5 and 6, and the total travel distance is not optimized.

### Effects of Present Embodiment

In the garbage collection system 1 according to the present embodiment, it is possible to accurately predict the “amount of garbage for each mesh”, which fluctuates according to the population change indicated by the population change data, for each garbage type.

In addition, by solving an optimization problem to minimize the total travel distance of garbage trucks and the total number of garbage trucks based on the predicted amount of garbage value for each mesh that can be accurately predicted as described above, it is possible to determine the garbage collection route that optimizes both the total travel distance and the total number of garbage trucks as shown in FIG. 5 out of the three examples shown in FIGS. 5 to 7. In addition, based on the garbage collection amount for each garbage truck based on the determined garbage collection route and the information on the number of required personnel according to the garbage collection amount set in advance as rules, it is possible to appropriately determine the assignment of personnel to each garbage truck.

### First Modification Example

A first modification example is an example in which, when the collection route determination unit 22 determines a garbage collection route, the above-described method (b) “method of generating a garbage collection route determination model for determining the garbage collection route for each garbage truck by machine learning and determining the garbage collection route for each garbage truck by using the garbage collection route determination model” is adopted.

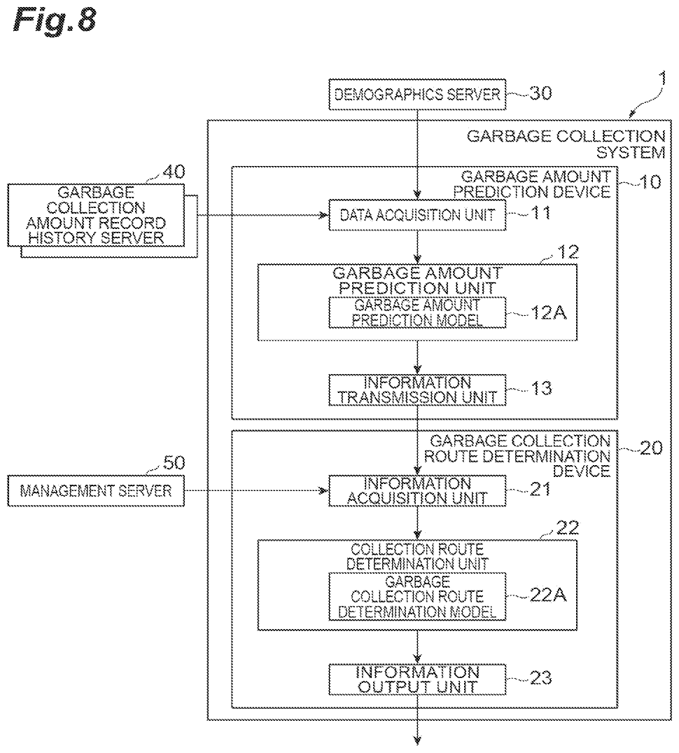

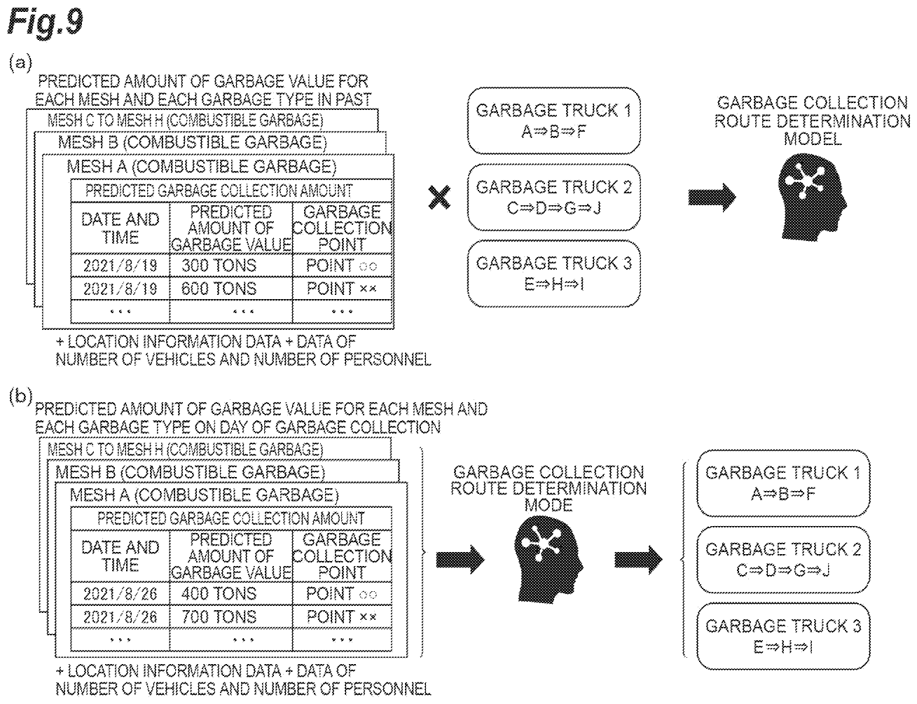

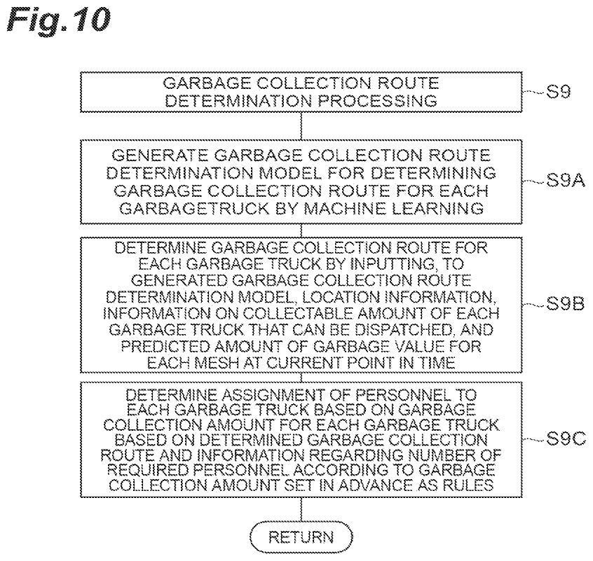

As shown in FIG. 8, in the garbage collection system 1 according to the first modification example, the collection route determination unit 22 generates, stores, and manages a garbage collection route determination model 22A for determining the garbage collection route as follows. More specifically, as shown in FIGS. 9(a) and 10, the collection route determination unit 22 generates the garbage collection route determination model 22A for determining the garbage collection route for each garbage truck by performing machine learning by using, as explanatory variables, location information, information on the collectable amount of each garbage truck, and the predicted amount of garbage value for each mesh when determining the collection route in the past and, as an objective variable, the garbage collection route for each garbage truck determined at the time of corresponding collection route determination (step S9A in FIG. 10). Then, as shown in FIGS. 9(b) and 10, the collection route determination unit 22 determines the garbage collection route for each garbage truck by inputting to the generated garbage collection route determination model 22A the above-described location information, the information on the collectable amount of each garbage truck, and the predicted amount of garbage value for each mesh at the current point in time (step S9B in FIG. 10).

In addition, the collection route determination unit 22 determines the assignment of personnel to each garbage truck based on the garbage collection amount for each garbage truck based on the determined garbage collection route and the rule information regarding the number of required personnel according to the garbage collection amount (step S9C in FIG. 10).

According to the first modification example described above, it is possible to generate a garbage collection route determination model for determining the garbage collection route based on the predicted amount of garbage value for each mesh that can be accurately predicted and to determine the garbage collection route that optimizes both the total travel distance and the total number of garbage trucks as shown in FIG. 5 out of the above-described three examples shown in FIGS. 5 to 7 by using the generated garbage collection route determination model. In addition, it is possible to appropriately determine the assignment of personnel to each garbage truck based on the garbage collection amount for each garbage truck based on the determined garbage collection route and the information on the number of required personnel according to the garbage collection amount set in advance as rules.

### Second Modification Example

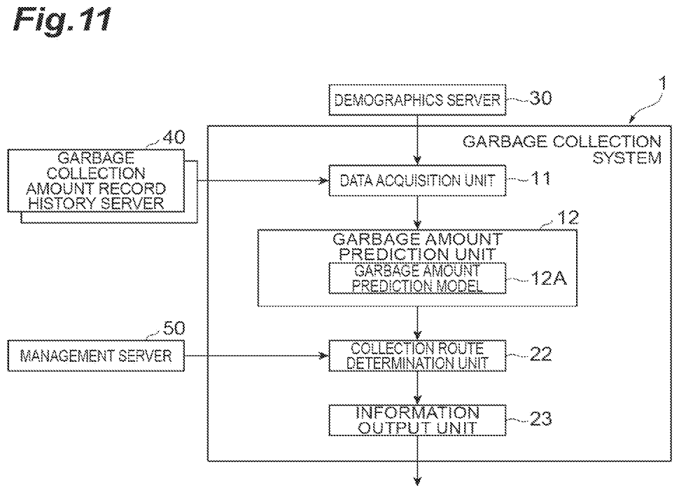

It is not essential that the garbage collection system 1 includes the garbage amount prediction device 10 and the garbage collection route determination device 20 as shown in FIGS. 1 and 8, and the garbage collection system 1 may be a single device as shown in FIG. 11. In this case, the information transmission unit 13 and the information acquisition unit 21 for transmission and reception of information between devices may be omitted, and the collection route determination unit 22 may acquire information directly from each of the garbage amount prediction unit 12, the garbage collection amount record history server 40, and the management server 50. Even in the garbage collection system 1 having such a configuration, the same processing as in the garbage collection system 1 shown in FIGS. 1 and 8 can be performed, and the same effect can be achieved.

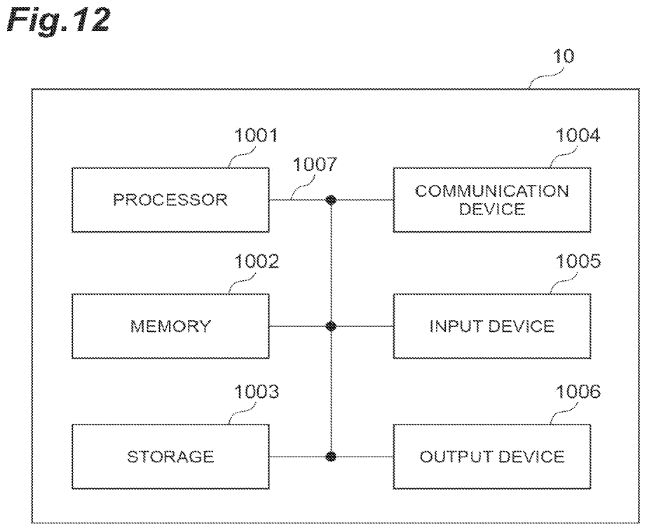

### (Explanation of Terms, Explanation of Hardware Configuration (FIG. 12), and the Like)

In addition, both the garbage amount prediction model 12A (FIGS. 1, 8, and 11) and the garbage collection route determination model 22A (FIG. 8) described above are so-called trained models, and are assumed to be used as program modules that are parts of artificial intelligence software. That is, these trained models are “commands for a computer” used in a computer including a processor (CPU) and a memory as shown in FIG. 12 described later, and are a combination of commands for a computer to obtain a single result (execute predetermined processing), that is, computer programs that cause the computer to function. In other words, the trained models described above are a combination of the structure of a neural network and a parameter (weighting coefficient) that is the strength of the connection between neurons in the neural network. Specifically, the processor (CPU) of the computer operates according to commands from the garbage amount prediction model 12A stored in the memory so that the predicted amount of garbage value in each mesh of the target garbage type is output with the population change data for each mesh in the prediction target period as an input value. In addition, the processor (CPU) of the computer operates according to commands from the garbage collection route determination model 22A stored in the memory so that the garbage collection route for each garbage truck corresponding to the target garbage type is output with the predicted amount of garbage value for each target garbage type on the day of garbage collection, location information regarding the departure points and destinations of garbage trucks and garbage collection locations for each mesh, and information on the collectable amount of each garbage truck as input values.

In addition, the block diagrams used in the description of the above embodiment show blocks in functional units. These functional blocks (configuration units) are realized by any combination of at least one of hardware and software. In addition, a method of realizing each functional block is not particularly limited. That is, each functional block may be realized using one physically or logically coupled device, or may be realized by connecting two or more physically or logically separated devices directly or indirectly (for example, using a wired or wireless connection) and using the plurality of devices. Each functional block may be realized by combining the above-described one device or the above-described plurality of devices with software.

Functions include determining, calculating, computing, processing, deriving, investigating, searching, ascertaining, receiving, transmitting, outputting, accessing, resolving, selecting, choosing, establishing, comparing, assuming, expecting, regarding, broadcasting, notifying, communicating, forwarding, configuring, reconfiguring, allocating, mapping, assigning, and the like, but are not limited thereto. For example, a functional block (configuration unit) that makes the transmission work is called a transmitting unit or a transmitter. In any case, as described above, the implementation method is not particularly limited.

For example, the garbage amount prediction device in the garbage collection system of the present disclosure may function as a computer that performs processing in the present embodiment. FIG. 12 is a diagram showing an example of the hardware configuration of the garbage amount prediction device 10. The garbage amount prediction device 10 described above may be physically configured as a computer device including a processor 1001, a memory 1002, a storage 1003, a communication device 1004, an input device 1005, an output device 1006, a bus 1007, and the like. Hereinafter, the garbage amount prediction device 10 will be described as an example, but the same applies to other devices (garbage collection route determination device 20) that form the garbage collection system.

In addition, in the following description, the term “device” can be read as a circuit, a unit, and the like. The hardware configuration of the garbage amount prediction device 10 may include one or more devices for each device shown in the diagram, or may not include some devices.

Each function in the garbage amount prediction device 10 is realized by reading predetermined software (program) onto hardware, such as the processor 1001 and the memory 1002, so that the processor 1001 performs an operation and controlling communication by the communication device 1004 or controlling at least one of reading and writing of data in the memory 1002 and the storage 1003.

The processor 1001 controls the entire computer by operating an operating system, for example. The processor 1001 may be configured by a central processing unit (CPU) including an interface with a peripheral device, a control device, an operation device, a register, and the like.

In addition, the processor 1001 reads a program (program code), a software module, data, and the like into the memory 1002 from at least one of the storage 1003 and the communication device 1004, and executes various kinds of processing according to these. As the program, a program causing a computer to execute at least a part of the operation described in the above embodiment is used. Although it has been described that the various kinds of processes described above are performed by one processor 1001, the various kinds of processes described above may be performed simultaneously or sequentially by two or more processors 1001. The processor 1001 may be realized by one or more chips. In addition, the program may be transmitted from a network through a telecommunication line.

The memory 1002 is a computer-readable recording medium, and may be configured by at least one of, for example, a ROM (Read Only Memory), an EPROM (Erasable Programmable ROM), an EEPROM (Electrically Erasable Programmable ROM), and a RAM (Random Access Memory). The memory 1002 may be called a register, a cache, a main memory (main storage device), and the like. The memory 1002 can store a program (program code), a software module, and the like that can be executed to implement the radio communication method according to an embodiment of the present disclosure.

The storage 1003 is a computer-readable recording medium, and may be configured by at least one of, for example, an optical disk such as a CD-ROM (Compact Disc ROM), a hard disk drive, a flexible disk, and a magneto-optical disk (for example, a compact disk, a digital versatile disk, and a Blu-ray (Registered trademark) disk), a smart card, a flash memory (for example, a card, a stick, a key drive), a floppy (registered trademark) disk, and a magnetic strip. The storage 1003 may be called an auxiliary storage device. The storage medium described above may be, for example, a database including at least one of the memory 1002 and the storage 1003, a server, or other appropriate media.

The communication device 1004 is hardware (transmitting and receiving device) for performing communication between computers through at least one of a wired network and a radio network, and is also referred to as, for example, a network device, a network controller, a network card, and a communication module.

The input device 1005 is an input device (for example, a keyboard, a mouse, a microphone, a switch, a button, and a sensor) for receiving an input from the outside. The output device 1006 is an output device (for example, a display, a speaker, and an LED lamp) that performs output to the outside. In addition, the input device 1005 and the output device 1006 may be integrated (for example, a touch panel). In addition, respective devices, such as the processor 1001 and the memory 1002, are connected to each other by the bus 1007 for communicating information. The bus 1007 may be configured using a single bus, or may be configured using a different bus for each device.

Each aspect/embodiment described in the present disclosure may be used alone, may be used in combination, or may be switched and used according to execution. In addition, the notification of predetermined information (for example, notification of “X”) is not limited to being explicitly performed, and may be performed implicitly (for example, without the notification of the predetermined information).

While the present disclosure has been described in detail, it is apparent to those skilled in the art that the present disclosure is not limited to the embodiments described in the present disclosure. The present disclosure can be realized as modified and changed aspects without departing from the spirit and scope of the present disclosure defined by the description of the claims. Therefore, the description of the present disclosure is intended for illustrative purposes, and has no restrictive meaning to the present disclosure.

In the processing procedure, sequence, flowchart, and the like in each aspect/embodiment described in the present disclosure, the order may be changed as long as there is no contradiction. For example, for the methods described in the present disclosure, elements of various steps are presented using an exemplary order. However, the present invention is not limited to the specific order presented.

The information and the like that are input and output may be stored in a specific place (for example, a memory) or may be managed using a management table. The information and the like that are input and output can be overwritten, updated, or added. The information and the like that are output may be deleted. The information and the like that are input may be transmitted to other devices.

The description “based on” used in the present disclosure does not mean “based only on” unless otherwise specified. In other words, the description “based on” means both “based only on” and “based at least on”.

When “include”, “including”, and variations thereof are used in the present disclosure, these terms are intended to be inclusive similarly to the term “comprising”. In addition, the term “or” used in the present disclosure is intended not to be an exclusive-OR.

In the present disclosure, when articles, for example, a, an, and the in English, are added by translation, the present disclosure may include that nouns subsequent to these articles are plural.

In the present disclosure, the expression “A and B are different” may mean “A and B are different from each other”. In addition, the expression may mean that “A and B each are different from C”. Terms such as “separated”, “coupled” may be interpreted similarly to “different”.

### REFERENCE SIGNS LIST

1: garbage collection system, 10: garbage amount prediction device, 11: data acquisition unit, 12: garbage amount prediction unit, 12A: garbage amount prediction model, 13: information transmission unit, 20: garbage collection route determination device, 21: information acquisition unit, 22: collection route determination unit, 22A: garbage collection route determination model, 23: information output unit, 30: demographic statistics server, 40: garbage collection amount record history server, 50: management server, 1001: processor, 1002: memory, 1003: storage, 1004: communication device, 1005: input device, 1006: output device, 1007: bus.

1. A garbage collection system, comprising:
a data acquisition unit that acquires population change data for each of districts divided in advance and garbage amount record data for each of the districts and each of garbage types; and
a garbage amount prediction unit that predicts an amount of garbage in each of the districts for each of the garbage types based on the population change data for each of the districts and the garbage amount record data for each of the districts and each of the garbage types that have been acquired by the data acquisition unit.

2. The garbage collection system according to claim 1,
wherein the garbage amount prediction unit generates a garbage amount prediction model, which predicts an amount of garbage in each of the districts, for each of the garbage types by performing machine learning for each of the garbage types by using, as an explanatory variable, population change data for each of the districts in a past predetermined period and, as an objective variable, garbage amount record data for each of the districts and each of the garbage types in the predetermined period, and
the garbage amount prediction unit predicts an amount of garbage in each of the districts in a prediction target period, for each of the garbage types, by inputting population change data for each of the districts in the prediction target period to the generated garbage amount prediction model for each of the garbage types.

3. The garbage collection system according to claim 1, further comprising:
a collection route determination unit that determines, for each of the garbage types, a garbage collection route for each of garbage trucks used for garbage collection based on at least location information regarding departure points and destinations of the garbage trucks and garbage collection locations for each of the districts, information on a collectable amount of each of the garbage trucks, and a predicted amount of garbage value for each of the districts obtained by prediction of the garbage amount prediction unit.

4. The garbage collection system according to claim 3,
wherein, for each of the garbage types, the collection route determination unit determines a garbage collection route for each of the garbage trucks by solving an optimization problem to minimize an evaluation function, which has the garbage collection route for each of the garbage trucks as a variable and of which output values are a total travel distance of the garbage trucks and the total number of garbage trucks, with the location information regarding the departure points and destinations of the garbage trucks and the garbage collection locations for each of the districts, the information on the collectable amount of each of the garbage trucks, and the predicted amount of garbage value for each of the districts as constraints.

5. The garbage collection system according to claim 3,
wherein, for each of the garbage types, the collection route determination unit generates a garbage collection route determination model, which determines a garbage collection route for each of the garbage trucks, by performing machine learning by using, as explanatory variables, the location information, the information on the collectable amount of each of the garbage trucks, and the predicted amount of garbage value for each of the districts when determining a collection route in past and, as an objective variable, the garbage collection route for each of the garbage trucks determined at the time of corresponding collection route determination, and determines a garbage collection route for each of the garbage trucks by inputting, to the generated garbage collection route determination model, the location information, the information on the collectable amount of each of the garbage trucks, and the predicted amount of garbage value for each of the districts at a current point in time.

6. The garbage collection system according to claim 3,
wherein, for each of the garbage types, the collection route determination unit further determines assignment of personnel to each garbage truck based on a garbage collection amount for each of the garbage trucks determined according to the determined garbage collection route and information on the number of required personnel according to a garbage collection amount set in advance as rules.

7. A trained model for causing a computer to function to output a predicted amount of garbage value in each of districts for a certain garbage type,
wherein the trained model is generated by machine learning using past population change data record values for each of the districts as an explanatory variable and garbage amount record values for each of the districts for the garbage type as an objective variable, and
the trained model causes the computer to function to output a predicted amount of garbage value for each of the districts for the garbage type with population change data for each of the districts in a prediction target period as an input value.

8. A trained model for causing a computer to function to determine a garbage collection route for each of garbage trucks collecting garbage of a predetermined garbage type,
wherein the trained model is generated by machine learning using, as explanatory variables, past garbage amount record values of the garbage type for each of districts, location information regarding departure points and destinations of the garbage trucks and garbage collection locations for each of the districts, and information on a collectable amount of each of the garbage trucks and, as an objective variable, past record information of a garbage collection route for each of the garbage trucks, and
the trained model causes the computer to function to output a garbage collection route for each of the garbage trucks of the garbage type with a predicted amount of garbage value for the garbage type, the location information regarding the departure points and destinations of the garbage trucks and the garbage collection locations for each of the districts, and the information on the collectable amount of each of the garbage trucks on a day of garbage collection as input values.

9. The garbage collection system according to claim 2, further comprising:
a collection route determination unit that determines, for each of the garbage types, a garbage collection route for each of garbage trucks used for garbage collection based on at least location information regarding departure points and destinations of the garbage trucks and garbage collection locations for each of the districts, information on a collectable amount of each of the garbage trucks, and a predicted amount of garbage value for each of the districts obtained by prediction of the garbage amount prediction unit.
